(19) United States
(12) Patent Application Publication
(10) Pub. No.: US 2012/0067641 A1
(43) Pub. Date: Mar. 22, 2012

(54) GLASS WITH TERMINAL

(75) Inventors: Junichi Tokiwa, Tokyo (JP); Miki Yoneyama, Kanagawa (JP)

(73) Assignees: 3M Innovative Properties Company; Nippon Sheet Glass Company

(21) Appl. No.: 13/254,968

(22) PCT Filed: Jan. 13, 2010
(86) PCT No.: PCT/JP2010/050269

§ 371 Date: Nov. 9, 2011

(30) Foreign Application Priority Data
Mar. 6, 2009 (JP) 2009-053281

(51) Int. Cl. H01R 4/00

(52) U.S. Cl. 174/84 R

(57) ABSTRACT

A glass-with-terminal, in which a terminal is bonded to a glass without using solder, is disclosed. The glass-with-terminal has a configuration wherein a terminal (14) is bonded to a glass (11) provided on the surface thereof with a silver print (12). The terminal (14) includes a bent portion (21) formed, in at least one end of the terminal, to be bent toward the silver print (12). The terminal (14) is bonded to the glass (11) through an adhesive (23), so that the bent portion (21) makes contact with the upper surface of the silver print (12).

### TECHNICAL FIELD

The present invention relates to a glass having a terminal (i.e., a “glass-with-terminal”), in which a terminal is bonded to a glass provided on the surface thereof with a silver print.

### BACKGROUND ART

For example, a vehicle window glass is provided on the surface thereof with a silver print, and a terminal for supplying electricity to the silver print is bonded to the glass. The silver print is used as an antenna, and is connected via the terminal to a radio or TV unit provided in the vehicle. The silver print is also used as a conductor for a heating wire used for defogging the glass (see, e.g., Patent Literature 1 and Patent Literature 2).

FIG. 11 shows a glass-with-terminal disclosed in Patent Literature 1. Referring to FIG. 11, a terminal 100 is configured by legs 105, 106 bonded via solders 103, 104 to an upper side of a glass plate 102 with an electrically conductive film 101 coated on the upper surface thereof, and a support part 107 disposed at the end of the leg 106. A lead wire 109 extends from the end of a joint part 108 joined to the support part 107 to, e.g., an apparatus disposed in the vehicle, such as an electric power source.

In the configuration of the terminal 100, higher contact strength is ensured by increasing a bonding area of the solder 103, 104. However, in recent years, in view of reducing environmental concerns, it is desired to reduce the use of solder containing lead as much as possible.

FIG. 12 shows a terminal structure disclosed in Patent Literature 2. Referring to FIG. 12, a T-shaped terminal 110 includes a female-type terminal part 111 disposed at the distal end of a stem, and is bonded to a glass through an adhesive 112 and solder 113.

According to the T-shaped terminal 110, the usage of the solder can be reduced by using the adhesive 112 together with the solder 113. However, in this case, it is necessary to use the solder in order to reinforce the bonding strength of the adhesive.

If lead-free solder is used, the melting temperature thereof is higher and thus a stress generating at the time of solidification thereof is also higher compared to solder containing lead, and therefore, a glass is subjected to a greater load. Also, lead-free solder is higher in hardness than solder containing lead, and is therefore more readily broken by shock.

Further, in many recent designs, a terminal used for a window glass of a vehicle is mounted in the interior of the vehicle and is covered by an interior finishing material. A space inside the interior finishing material is limited, and the terminal has to be arranged inside the limited space. Thus, it is necessary to use a lead-free terminal without changing layout and a connecting condition for a vehicle-side connector.

Further, if an adhesive is provided directly on a surface of a silver print, long-term reliability of bonding strength is low. Therefore, it is desired to provide a glass-with-terminal, in which a terminal is bonded without using solder.

### Citation List

### Patent Literature

Patent Literature 1: Japanese Patent No. 3957302

Patent Literature 2: Japanese Unexamined Patent Publication No. 2003-521093

### SUMMARY OF INVENTION

### Technical Problem

It is an object of the present invention to provide a glass-with-terminal, in which a terminal is bonded without using solder.

### Solution to Problem

According to an aspect of the present invention, there is provided a glass-with-terminal, comprising a glass; a silver print provided on a surface of said glass; a terminal bonded to said glass provided with said silver print; wherein said terminal includes a terminal part adapted to be connected to an electrical component and a base part supporting said terminal part, said base part including a bent portion formed to be bent toward said silver print, said base part being made by using a material thinner than a material of said terminal part; and wherein said base part is bonded to said glass through an adhesive, so that said bent portion makes contact with an upper surface of said silver print.

Preferably, said adhesive is disposed on a non-printed area formed by cutting away a part of an extended pattern; and wherein said terminal is bonded to said glass at said non-printed area with said bent portion contacting the upper surface of said silver print.

Preferably, said bent portion includes a plurality of contact points contacting the upper surface of said silver print.

Preferably, said bent portion includes a distal end portion formed in an arcuate cross-sectional shape.

Preferably, said terminal has a height of 25 mm or less.

Preferably, said terminal has a width of 15 mm or less.

Preferably, said terminal has a length of 50 mm or less.

Preferably, said adhesive become hardened at room temperature.

Preferably, said base part is provided with at least one through-hole, and wherein said base part is sandwiched by said adhesive through said through-hole.

Preferably, said base part has a thickness in a range of 0.1 mm to 0.6 mm.

In another aspect of the present invention, there is provided a glass-with-terminal, comprising a glass; a silver print provided on a surface of said glass; a terminal bonded to said glass provided with said silver print; wherein said terminal includes a terminal part adapted to be connected to an electrical component and a base part supporting said terminal part, said base part including a bent portion formed to be bent toward said silver print, said base part being made by using a material thinner than a material of said terminal part; wherein said base part is bonded to said glass through an adhesive, so that said bent portion makes contact with an upper surface of said silver paint; and wherein said terminal is bonded to the upper surface of said silver print, the bonding surface of said silver print being previously treated with a primer.

In still another aspect of the present invention, there is provided a vehicle comprising an above-described glass-with-terminal mounted thereon.

### EFFECTS OF INVENTION

The terminal includes the bent portion bent toward the silver print. A spring structure is obtained by bending the terminal, which urges the terminal in the direction of contact relative to the silver print. According to this structure, contact strength can be increased, which otherwise may be inadequate when only adhesive is used, and thus sufficient contact strength can be obtained.

The base part is thinner than the terminal part. By forming the base part thinner than the terminal part, the separation of the terminal due to repulsive force of the base part can be prevented, and the size of the terminal can be reduced.

The terminal is bonded to the glass at the non-printed area where the silver print is not applied. In other words, an adhesive layer for bonding the terminal to the glass is directly disposed on the upper surface of the glass. When the adhesive layer is disposed directly on the upper surface of the glass, as compared to an adhesive layer disposed on the upper surface of the silver print, initial adhesion strength is equivalent to that of the latter, but a remarkable effect (78.4 N or more) is verified through a humidity resistance test (50° C., RH 90% or higher, for 720 hrs). The non-printed area also includes, besides the glass surface, a black ceramic print area printed on the glass surface. In other words, the term “non-printed” of the non-printed area means that no silver print is provided.

The plurality of contact points contacting the upper surface of the silver print are provided. In other words, the terminal makes contact with the silver print at the plurality of contact points. As a result, the contact area of the terminal in contact with the silver print can be increased, and thereby the function of the terminal 14 can be stably exerted, even if the terminal is subjected to a flow of a large current or used in a location subjected to vibration. The configuration of the plurality of contact points is an effective means for preventing the occurrence of a spark due to the separation of the contact point when a large current is passed.

The distal end of the bent portion is formed in an arcuate cross-sectional shape. Due to the arcuate shape, a sharp contact point is eliminated, and thus the wear of the silver print can be prevented. The lifetime of the glass-with-terminal 10 is thereby increased.

The terminal is formed smaller than a specified size. In a spring contact structure, it is difficult to ensure installation volume, which may be accomplished by a conventional terminal using solder containing lead, and therefore, a separate structure of the present invention is required.

The adhesive becomes hardened at room temperature. If the hardening occurs at room temperature, residual stress caused in the glass due to a temperature difference at the time of rapid cooling can be suppressed as compared to a case wherein the hardening occurs at higher temperature.

The base part is provided with a single through-hole, and the base part is sandwiched in the adhesive via the through-hole. By sandwiching the base part in the adhesive, adhesion strength can be increased.

The base part has the thickness in the range of 0.1 mm to 0.6 mm. If the thickness is less than 0.1 mm, rigidity is inadequate, and if the thickness exceeds 0.6 mm, the remarkable effect of the reduction in thickness is deteriorated. Thus, according to the thickness of the base part in the range of 0.1 mm to 0.6 mm, a predetermined rigidity is ensured and the remarkable effect of the present invention is obvious.

The terminal is bonded to the glass at the upper surface of the silver print, and the silver print is previously treated with the primer. According to the pre-treatment with the primer, initial adhesion strength is equivalent, but high adhesion strength (78.4 N or higher) can be obtained through a humidity resistance test (50° C., RH 90% or higher, for 720 hrs).

The glass-with-terminal according to the present invention is suitable for an automobile that may be subjected to an external load, such as vibrations.

### BRIEF DESCRIPTION OF DRAWINGS

FIG. 1 is a front view showing a glass-with-terminal according to embodiment 1 of the present invention.

FIG. 2 is a cross-sectional view taken along a line 2-2 of FIG. 1.

FIG. 3 is a view as seen in the direction of an arrow 3 of FIG. 2.

FIG. 4 is a view showing a manufacturing process of a glass-with-terminal according to embodiment 1.

FIG. 5 is a view showing a manufacturing process of a glass-with-terminal according to embodiment 2.

FIG. 6 is a view showing a manufacturing process of a glass-with-terminal according to embodiment 3.

FIG. 7 is a cross-sectional view showing a glass-with-terminal according to embodiment 4.

FIG. 8 is a cross-sectional view showing a glass-with-terminal according to embodiment 5.

FIG. 9 is a cross-sectional view showing a glass-with-terminal according to embodiment 6.

FIG. 10 is a view showing an exemplary process of joining a terminal part to a base part.

FIG. 11 is a cross-sectional view showing a conventional glass-with-terminal according to Patent Literature 1.

FIG. 12 is a view showing a conventional terminal according to Patent Literature 2.

### MODE FOR CARRYING OUT THE INVENTION

Some preferred embodiments of the present invention will be described below with reference to appended drawings.

### Embodiment 1

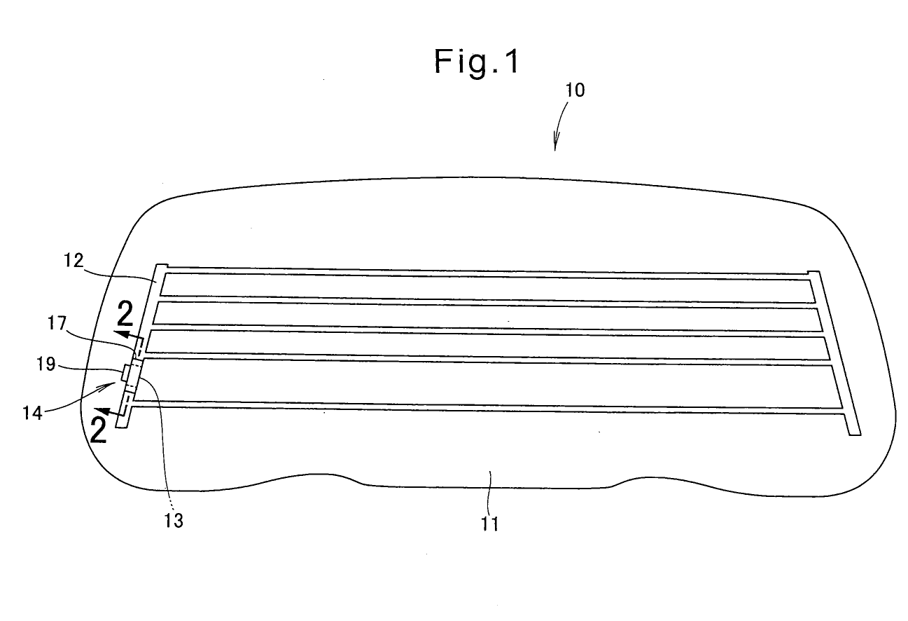

FIGS. 1 to 4 depict embodiment 1 of the present invention. Referring to FIG. 1, a glass-with-terminal 10 includes a glass 11 such as a window pane of a vehicle, a silver print 12 provided on the surface of the glass 11 and capable of functioning as an antenna, a non-printed area 13 free of the silver print 2, and a terminal 14 bonded to the glass 11 at the non-printed area 13 and electrically connecting vehicle-mounted units to the silver print 12.

Non-printed area 13 can be formed by masking a part of the surface of the glass 11 during a printing process of the silver print 12. Alternatively, it may be formed by cutting away a part of the silver print 12 after the silver print has been provided. Thus, a process of forming the non-printed area 13 can be optionally selected, as long as a resultant non-printed portion is obtained. It is advantageous to adopt the process of masking a part of the surface of the glass 11, since the non-printed area 13 can be formed in a short time.

On the other hand, if a conventionally-produced glass on which a silver print 12 is provided is used, the non-printed area 13 may be formed by cutting away a part of the silver print 12. Thus, the glass-with-terminal 10 can be manufactured by using a conventional glass-with-terminal. In this case, the terminal 14 can be arranged in a layout similar to a conventional terminal layout, and thus the glass-with-terminal 10 can be easily manufactured.

The non-printed area 13 also includes, besides the glass surface, a black ceramics print area printed on the glass surface. In other words, the term “non-printed” of the non-printed area means that no silver print is provided.

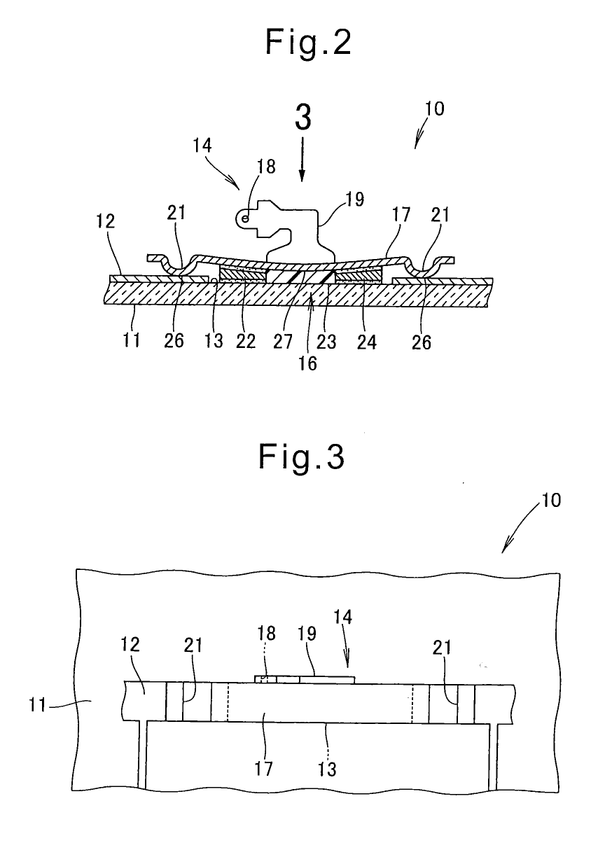

As depicted in FIG. 2, it is desirable that, before an adhesive 23 is applied, an oxide film is removed from the silver print 12. In this case, the adhesion strength of the adhesive 23 in relation to the silver print 12 can be increased.

It is desirable that the adhesive 23 become hardened at room temperature. If the hardening occurs at room temperature, residual stress caused in the glass 11 due to a temperature difference at the time of rapid cooling can be suppressed as compared to a case wherein the hardening occurs at higher temperature (e.g., at 150° C.).

As depicted in FIG. 2, the terminal 14 is formed by two plates having different thicknesses, and includes a base part 17 (e.g., 0.4 mm in thickness) with a lower surface thereof being bonded to an adhesive layer 16, and a terminal part 19 (e.g., 0.8 mm in thickness) extending upright from the base part 17 and connected at a female-type terminal portion 18 to TV unit or the like provided in the interior of a vehicle. The thickness of the base part 17 is smaller than the thickness of the terminal part 19, and may be in the range of 0.1 mm to 0.6 mm including the above-mentioned 0.4 mm.

It is desirable that the terminal 14 has a height of 25 mm or less, a width of 15 mm or less, and a length of 50 mm or less. Thus, the terminal 14 is formed with a size smaller than a predetermined size. In a spring contact structure, it is difficult to ensure permissible volume and adequate strength, which may be accomplished by using a conventional lead-containing-soldered terminal, if the base part 17 has a thickness equal to a thickness of the terminal part 19, and therefore, the separated structure of the present invention is required.

The base part 17 includes arcuate bent portions 21, 21 at opposite ends thereof, which are bent toward the silver print 12. The adhesive layer 16 is constructed by arranging a first double-sided tape 22, an adhesive 23, and a second double-sided tape 24, in the order from left to right in the drawing, along the longitudinal direction of the terminal 14. Reference numerals 26, 26 denote contact points at which the bent portions 21, 21 of the terminal 14 come into contact with the upper surface of the silver print 12. Thus, the terminal 14 contacts the upper surface of the silver print 12 at a plurality of contact points 26, 26.

In accordance with the glass-with-terminal 10, the terminal 14 includes the bent portions 21, 21 bent toward the silver print 12. A spring structure is obtained by bending the terminal 14, which enhances a force in the direction of contact made between the terminal 14 and the silver print 12. According to this structure, contact strength can be increased, which otherwise may be inadequate when only the adhesive 23 is used, and thus sufficient contact strength can be obtained.

The terminal 14 is bonded to the glass 11 at a non-printed area 13 where the silver print 12 is not applied. The adhesive layer for bonding the terminal 14 to the glass 11 is disposed directly on the upper surface of the glass 11. When the adhesive layer is directly disposed on the upper surface of the glass 11, as compared to an adhesive layer disposed on the upper surface of the silver print 12, initial adhesion strength is equivalent to that of the latter, but a remarkable effect (78.4 N or more) is verified through a humidity resistance test (50° C., RH of 90% or higher, for 720 hrs).

The terminal part 19 is formed so as to be thicker than the base part 17. In other words, the base part 17 is thinner than the terminal part 19. By forming the base part 17 thinner than the terminal part 19, a contact force generating toward the silver print is increased. High contact strength can be obtained while maintaining the function of the terminal part 19.

The plurality of contact points 26 contacting the upper surface of the silver print 12 are provided. The terminal 14 makes contact with the silver print 12 at the plurality of contact points 26. As a result, the contact area of the terminal 14 in contact with the silver print 12 can be increased, and thereby the function of the terminal 14 can be stably exerted, even if the terminal is subjected to a large current flow or used in a location subjected to vibration. The configuration of the plurality of contact points is an effective means for preventing the occurrence of a spark due to the separation of the contact point when a large current is passed.

The distal end of each of the bent portions 21, 21 is formed in an arcuate cross-sectional shape. Due to the arcuate shape, a sharp contact point is eliminated, and thus the wear of the silver print can be prevented. The lifetime of the glass-with-terminal 10 is thereby increased.

The above configuration can be summarized below.

In the glass-with-terminal 10, in which the terminal 14 is bonded to the glass 11 provided on the surface thereof with the silver print 12, the terminal 14 includes the base part 17 including the bent portions 21 formed to be bent toward the silver print 12 and the terminal part 19 thicker than the base part 17 and extending upright from the base part 17, and the terminal 14 is bonded to the glass 11 by the adhesive 23 so that the bent portions 21 make contact with the upper surface of the silver print 12.

The adhesive 23 is disposed at the non-printed area 13 of the glass 11, to which the silver print 12 is not applied. The terminal 14 is bonded to the glass 11 at the non-printed area 13, and thereby the bent portions 21 make contact with the upper surface of the silver print 12.

The plurality of contact points 23 contacting the upper surface of the silver print 12 are provided. The distal end of the bent portion 21 is formed in the arcuate cross-sectional shape.

In the above description, the adhesive layer 16 has an exemplary configuration in which the adhesive 23 is arranged between the first and second double-sided adhesive tapes 22, 24. However, the adhesive layer may be configured by arranging a double-sided adhesive tape between adhesives, or arranging side-by-side an adhesive and a double-sided adhesive tape. The arrangement of an adhesive and a double-sided tape is not limited to those described above. When a double-sided adhesive tape is arranged between adhesives, significantly high adhesion strength against a load in a tensile direction can be obtained.

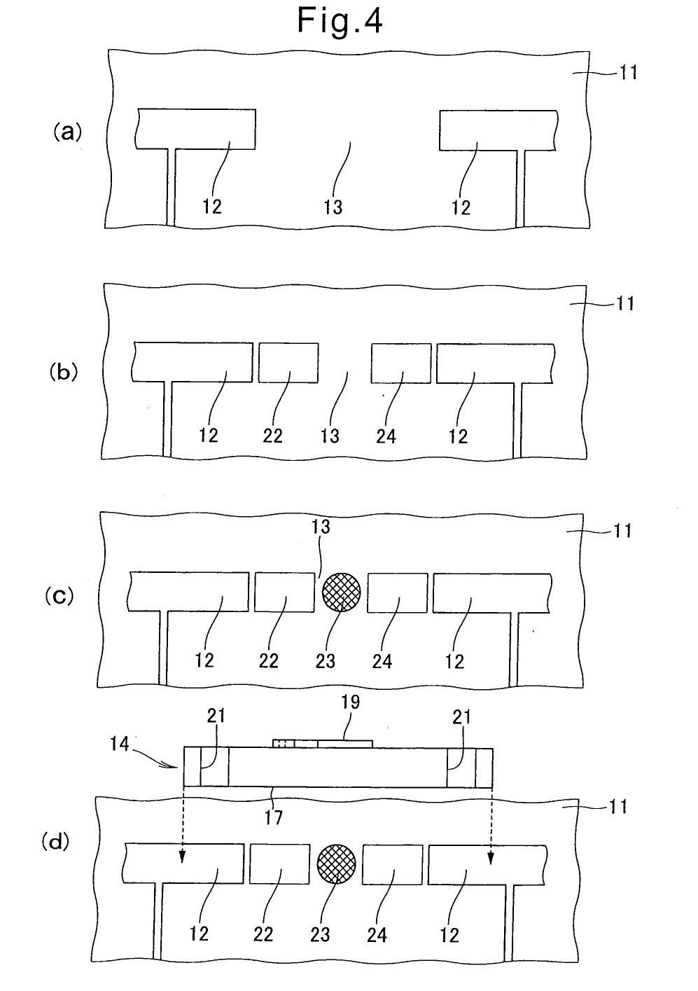

As depicted in FIG. 3, the terminal 14 is bonded to the glass 11 at the non-printed area 13 where the silver print 12 is not applied, and the bent portions 21, 21 formed at the opposite ends make contact with the upper surface of the silver print 12. A process for manufacturing the glass-with-terminal 10 will be described below with reference to FIG. 4.

First, as depicted in FIG. 4(a), the glass 11 having the non-printed area 13, to which the silver print 12 is not applied, is provided.

Next, as depicted in FIG. 4(b), the first double-sided adhesive tape 22 and the second double-sided adhesive tape 24 are attached to the opposite ends of the non-printed area 13.

As depicted in FIG. 4(c), the adhesive 23 is disposed between the double-sided adhesive tapes 22 and 24, and, as depicted in FIG. 4(d), the terminal 14 is arranged so that the opposite ends of the terminal 14 come into contact with the upper surface of the silver print 12. The terminal 14 is thereby bonded to the double-sided adhesive tapes 22, 24 and the adhesive 23. Thus, the glass-with-terminal 10 as depicted in FIG. 3 has been completely manufactured.

In this configuration, the adhesive 23 may be first disposed and thereafter the double-sided tapes 22, 24 may be disposed, or alternatively, the adhesive 23 may be disposed and simultaneously the double-sided tapes 22, 24 may be attached. In any case, the double-sided adhesive tapes 22, 24 function so as to temporarily fix the terminal 14 until the adhesive 23 become hardened. These steps may be carried out in any order, as long as they are carried out before the terminal 14 is arranged.

### Embodiment 2

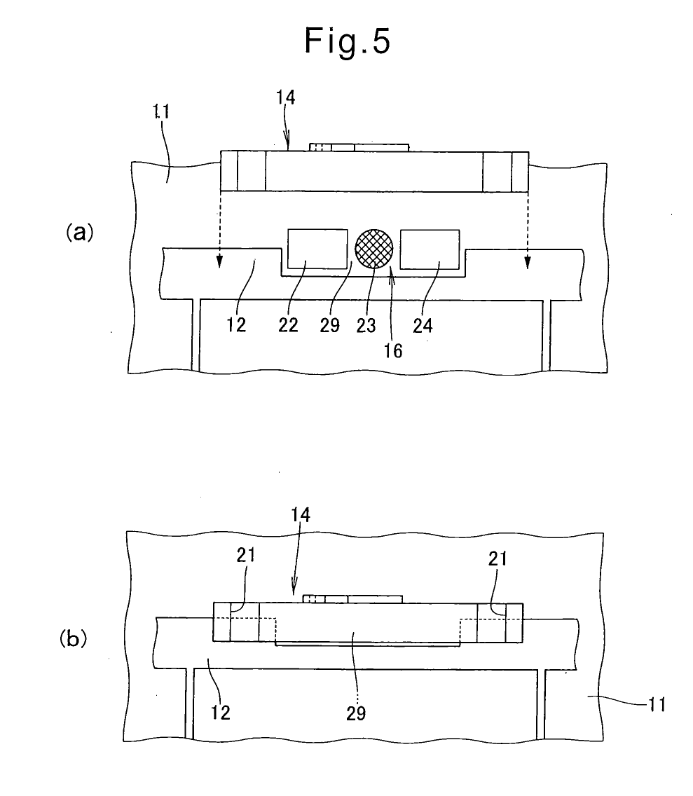

In the case where a non-printed area 29 is formed in the shape of a U-groove as depicted in FIG. 5(a), the terminal 14 also can be electrically connected to the silver print 12 as depicted in FIG. 5(b). Even in this case, the adhesive layer is directly disposed on the upper surface of the glass, which can bring about an advantageous effect of the present invention such that the adhesive layer is bonded to the glass with higher adhesion strength.

### Embodiment 3

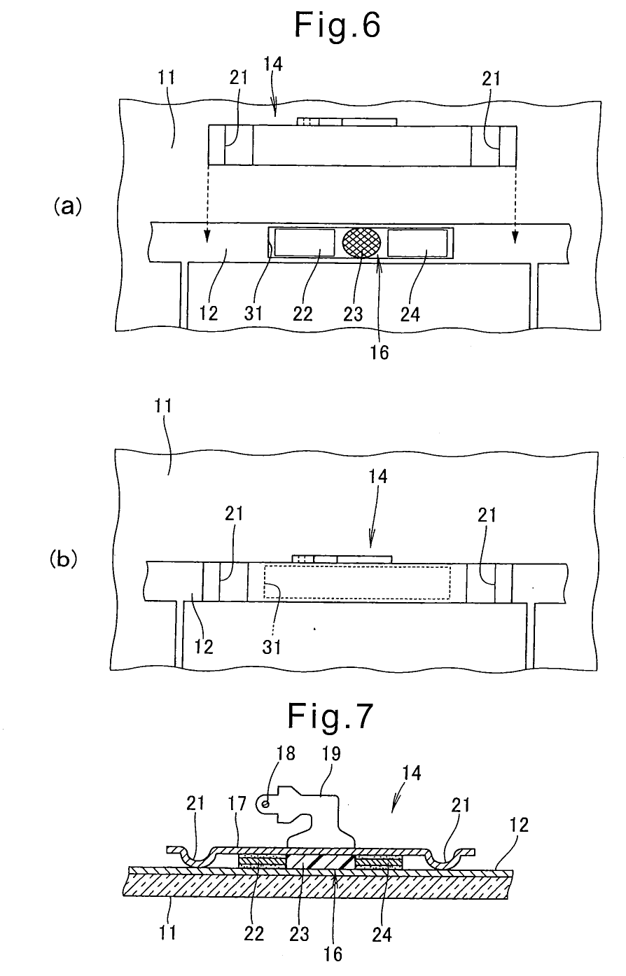

In the case where a non-printed area 31 is formed in the shape of a window as depicted in FIG. 6(a), the terminal 14 also can be electrically connected to the silver print 12 as depicted in FIG. 6(b). Even in this case, the adhesive layer is directly disposed on the upper surface of the glass, which can bring about an advantageous effect of the present invention such that the adhesive layer is bonded to the glass with higher strength.

### Embodiment 4

As depicted in FIG. 7, the adhesive layer 16 is disposed on the upper surface of the silver print 12. The terminal 14 is bonded to the glass 11 by the double-sided adhesive tapes 22, 24 and the adhesive 23. Even in this case, a force in the direction of contact made between the terminal 14 and the silver print 12, which can brings about an advantageous effect of the present invention such that contact strength can be increased, which otherwise likely be inadequate when only the adhesive 23 is used.

Further, when the silver print 12 is previously treated with a primer (a silane coupling agent), the following effect can be obtained.

In the glass-with-terminal, the terminal 14 being bonded to the glass 11 provided on the surface thereof with the silver print 12, the terminal 14 including the base part 17 including the bent portions 21 formed to be bent downward and the terminal part 19 thicker than the base part 17 and extending upright from the base part 17, and the terminal 14 being bonded to the glass 11 by the adhesive 23 so that the bent portions 21 make contact with the upper surface of the silver print 12, the terminal 14 is bonded to the glass 11 at the upper surface of the silver print, and the silver print 12 is previously treated with the primer.

According to the configuration wherein the silver print 12 is previously treated with the primer, as compared to the case where no previous treatment is performed, initial adhesion strength is equivalent to that of the latter, but high adhesion strength (78.4 N or higher) can be obtained through a humidity resistance test (50° C., RH 90% or higher, for 720 hrs).

### Embodiment 5

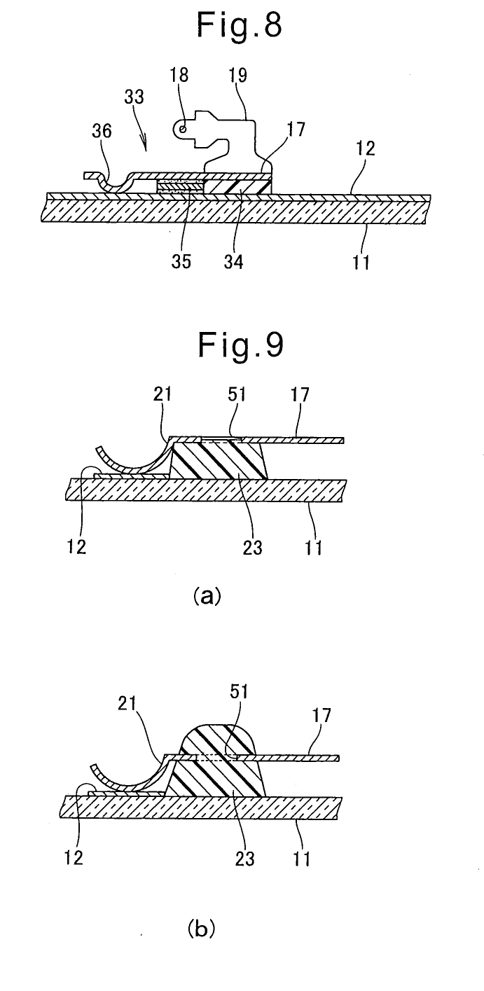

As depicted in FIG. 8, the bottom surface of a terminal 33 is bonded by an adhesive 34 and a double-sided tape 35. A bent portion 36 is formed at one end of the terminal 33, and the bent portion 36 makes contact with the silver print 12.

In the case where the non-printed area 13 (FIG. 2) is not provided in the silver print 12, or otherwise, the silver print 12 is electrically continuous in its entirety (FIG. 5(a), FIG. 6(a)), one end of the terminal 33 makes contact with the silver print 12 so that the silver print 12 can be electrically connected to the terminal 33. When the terminal 33 is used, the size of the terminal can be advantageously reduced.

### Embodiment 6

As depicted in FIG. 9(a), the base part 17 provided with a single through-hole 51 is used, which can bring about an advantageous effect of the present invention.

As depicted in FIG. 9(b), it is also possible to anchor or sandwich the base part 17 in the adhesive 23 via the through-hole 51. By anchoring the base part 17 in the adhesive 23, adhesion strength can be increased.

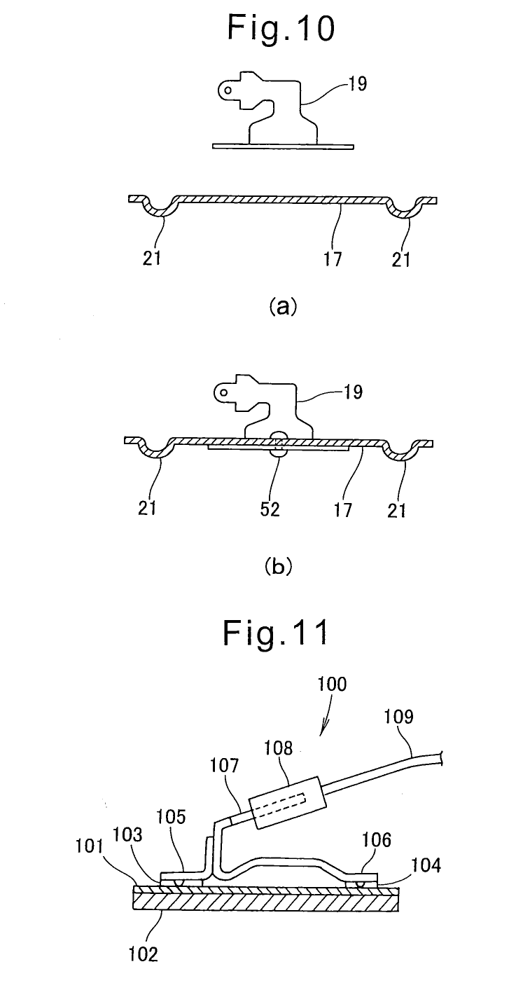

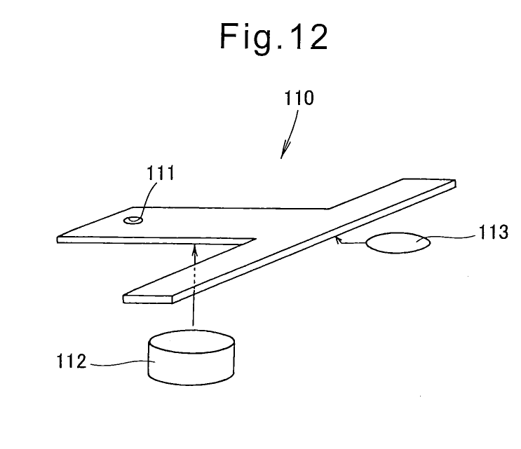

As depicted in FIG. 10(a), the terminal part 19 is joined to the base part 17 thinner than the terminal part 19. As depicted in FIG. 10(b), the joint face of the terminal part 19 is disposed at a lower side of the base part, and a rivet 52 is used to join the terminal portion 19 to the base portion 17 by caulking.

Any means other than the caulking may be used for the joint process, such as screw fastening, crimping, welding, etc. However, the caulking is preferred in view of strength and manufacturing cost.

The glass-with-terminal according to the embodiments of the present invention is applied to a four-wheeled vehicle. However, the application is not limited to the vehicle, and the glass-with-terminal may also be applied to a security glass in buildings, etc.

### INDUSTRIAL APPLICABILITY

The glass-with-terminal according to the present invention is suitable for use as a window pane of a four-wheeled vehicle.

### REFERENCE SIGNS LIST

10 . . . glass-with-terminal

11 . . . glass

12 . . . silver print

13, 29, 31 . . . non-printed area

14, 33 . . . terminal

17 . . . base part

19 . . . terminal part

21, 36 . . . bent portion

22 . . . (first) double-sided tape

23, 34 . . . adhesive

24 . . . (second) double-sided tape

26 . . . contact point

35 . . . double-sided tape

51 . . . through-hole

1. A glass-with-terminal, comprising:
a glass;
a silver print provided on a surface of said glass;
a terminal bonded to said glass provided with said silver print;
wherein said terminal includes a terminal part adapted to be connected to an electrical component and a base part supporting said terminal part, said base part including a bent portion formed to be bent toward said silver print, said base part being made by using a material thinner than a material of said terminal part; and
wherein said base part is bonded to said glass through an adhesive, so that said bent portion makes contact with an upper surface of said silver print.

2. A glass-with-terminal as set forth in claim 1, wherein said adhesive is disposed on a non-printed area formed by cutting away a part of an extended pattern; and
wherein said terminal is bonded to said glass at said non-printed area with said bent portion contacting the upper surface of said silver print.

3. A glass-with-terminal as set forth in claim 1, wherein said bent portion includes a plurality of contact points contacting the upper surface of said silver print.

4. A glass-with-terminal as set forth in claim 1, wherein said bent portion includes a distal end portion formed in an arcuate cross-sectional shape.

5. A glass-with-terminal as set forth in claim 1, wherein said terminal has a height of 25 mm or less.

6. A glass-with-terminal as set forth in claim 1, wherein said terminal has a width of 15 mm or less.

7. A glass-with-terminal as set forth in claim 1, wherein said terminal has a length of 50 mm or less.

8. A glass-with-terminal as set forth in claim 1, wherein said adhesive becomes hardened at room temperature.

9. A glass-with-terminal as set forth in claim 1, wherein said base part is provided with at least one through-hole, and wherein said base part is sandwiched by said adhesive through said through-hole.

10. A glass-with-terminal as set forth in claim 1, wherein said base part has a thickness in a range of 0.1 mm to 0.6 mm.

11. A glass-with-terminal, comprising:
a glass;
a silver print provided on a surface of said glass;
a terminal bonded to said glass provided with said silver print;
wherein said terminal includes a terminal part adapted to be connected to an electrical component and a base part supporting said terminal part, said base part including a bent portion formed to be bent toward said silver print, said base part being made by using a material thinner than a material of said terminal part;
wherein said base part is bonded to said glass through an adhesive, so that said bent portion makes contact with an upper surface of said silver paint; and
wherein said terminal is bonded to the upper surface of said silver print, the bonding surface of said silver print being previously treated with a primer.

12. A glass-with-terminal as set forth in claim 11, wherein said terminal has a height of 25 mm or less.

13. A glass-with-terminal as set forth in claim 11, wherein said terminal has a width of 15 mm or less.

14. A glass-with-terminal as set forth in claim 11, wherein said terminal has a length of 50 mm or less.

15. A glass-with-terminal as set forth in claim 11, wherein said adhesive become hardened at room temperature.

16. A glass-with-terminal as set forth in claim 11, wherein said base part is provided with at least one through-hole, and wherein said base part is sandwiched by said adhesive through said through-hole.

17. A glass-with-terminal as set forth in claim 11, wherein said base part has a thickness in a range of 0.1 mm to 0.6 mm.

18. A vehicle comprising a glass-with-terminal mounted thereon, the glass-with-terminal being as set forth in claim 1 to 17.
